(19) United States
(12) Patent Application Publication
(10) Pub. No.: US 2014/0240636 A1
(43) Pub. Date: Aug. 28, 2014

(54) DISPLAY AND ASSEMBLY METHOD THEREOF AND ELECTRONIC DEVICE USING SAME

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: TAI-AN TSAO, New Taipei (TW); TING-YU WANG, New Taipei (TW); XIAO-YU LIU, Shenzhen (CN); BO-DUO YUAN, Shenzhen (CN); LEI HAN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/872,154

(22) Filed: Apr. 28, 2013

(30) Foreign Application Priority Data
Feb. 26, 2013 (CN) 2013100592141

(51) Int. Cl. G06F 1/16; G02F 1/1333

(52) U.S. Cl. CPC G06F 1/1601; G02F 1/133308
USPC 349/58; 29/428

(57) ABSTRACT

An electronic device includes a cover and a display secured to the cover. The display includes a display screen and a display panel secured to the display screen. A plurality of engaging elements of the display panel are fixed to the display screen and form to an integrated display. The integrated display is secured to the cover.

### BACKGROUND

1. Technical Field

The present disclosure relates to electronic devices, and particularly to an electronic device having a display and an assembly method for assembling the display.

2. Description of Related Art

Referring to FIG. 4, electronic devices, such as a computer or a mobile phone, may include a display 1 assembled on a cover 2. The display 1 includes a display panel 10, a frame 20 defining a receiving space 22 and a display screen 30. The display panel 10 includes a plurality of engaging elements. The plurality of engaging elements includes a liquid crystal cell 13, a prism lens sheet 14, a diffuser 15, a light guide plate 16 and a reflection plate 17).

In assembly, the reflection plate 17, the light guide plate 16, the diffuser 15, the prism lens sheet 14 and the liquid crystal cell 13 adhere to the cover 2 one by one in the direction of the arrows shown. Then, the display screen 30 covers on the liquid crystal cell 13. The frame 20 is arranged on the cover 2, with the engaging elements of the display panel 10 and the display screen 30 received in the receiving space 22. However, the surface of the cover 2 may be uneven and easily deformed. Thus, when the engaging elements of the display panel 10 and the display screen 30 are adhered to the surface of the cover 2, an additional fixing component (not shown) is needed for positioning the engaging elements of the display panel 10 and the display screen 30 in assembly process, and the engaging elements of the display panel 10 and the display screen 30 may be uneven and difficult to adhere to each other tightly. Furthermore, because other components, such as, an antenna and a camera, may be assembled on the cover 2 first, it is difficult for an operator to assemble the engaging elements of the display panel 10 and the display screen 30 on the cover 2 one by one because of the limit space.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of an embodiment of an electronic device with a display.

FIG. 2 is a perspective view for explaining the assembly of the display of FIG. 1.

FIG. 3 is a flowchart of an assembly method of the display FIG. 2.

FIG. 4 is a perspective view for explaining the assembly of a display of a related art.

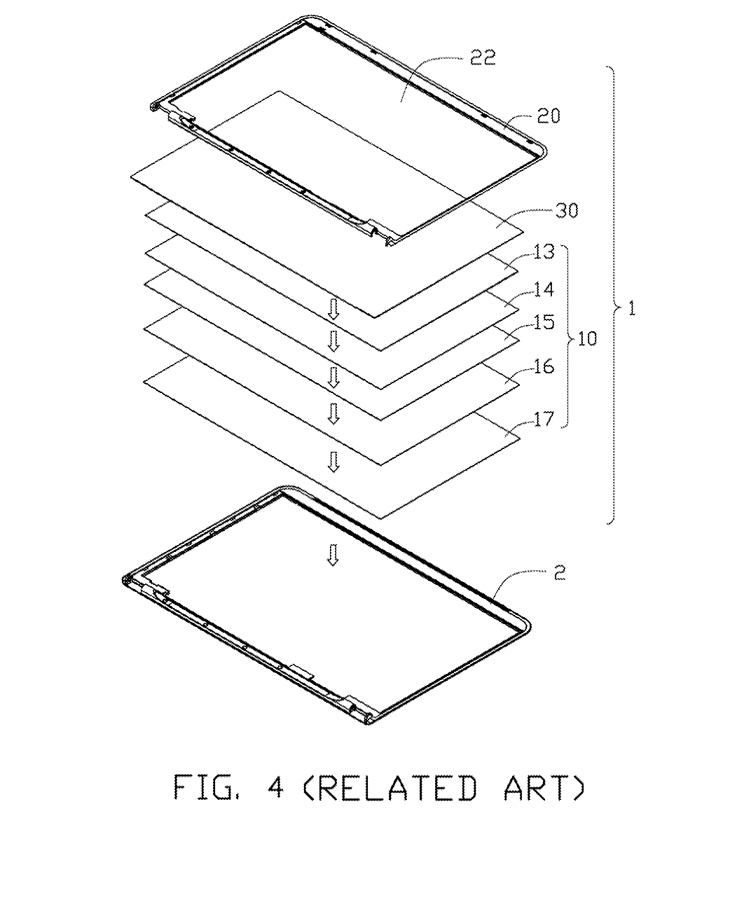

### DETAILED DESCRIPTION

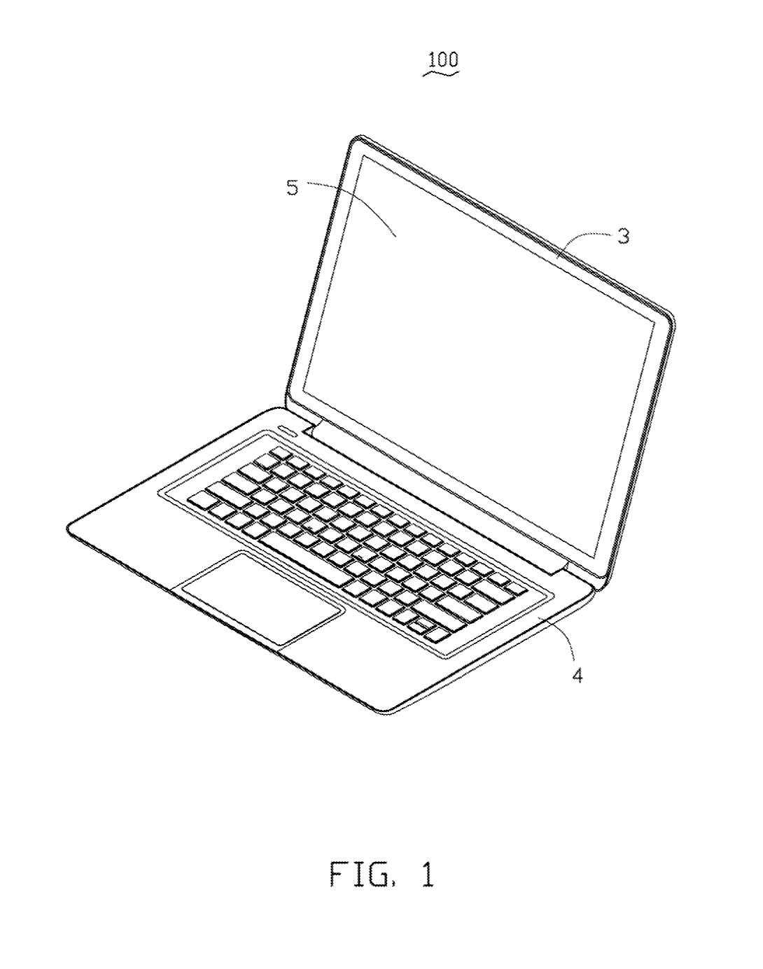

Referring to FIG. 1, an electronic device 100 includes a cover 3, a base 4 and a display 5. The display 5 is mounted on the cover 3. The cover 3 is rotatably connected to the base 4 and is capable of being opened and closed relative to the base 4. When the cover 3 is opened, the display 5 is exposed and capable of being viewed by users. The electronic device 100 may be a computer and a mobile phone, or the like. In the embodiment, the electronic device 100 is a computer.

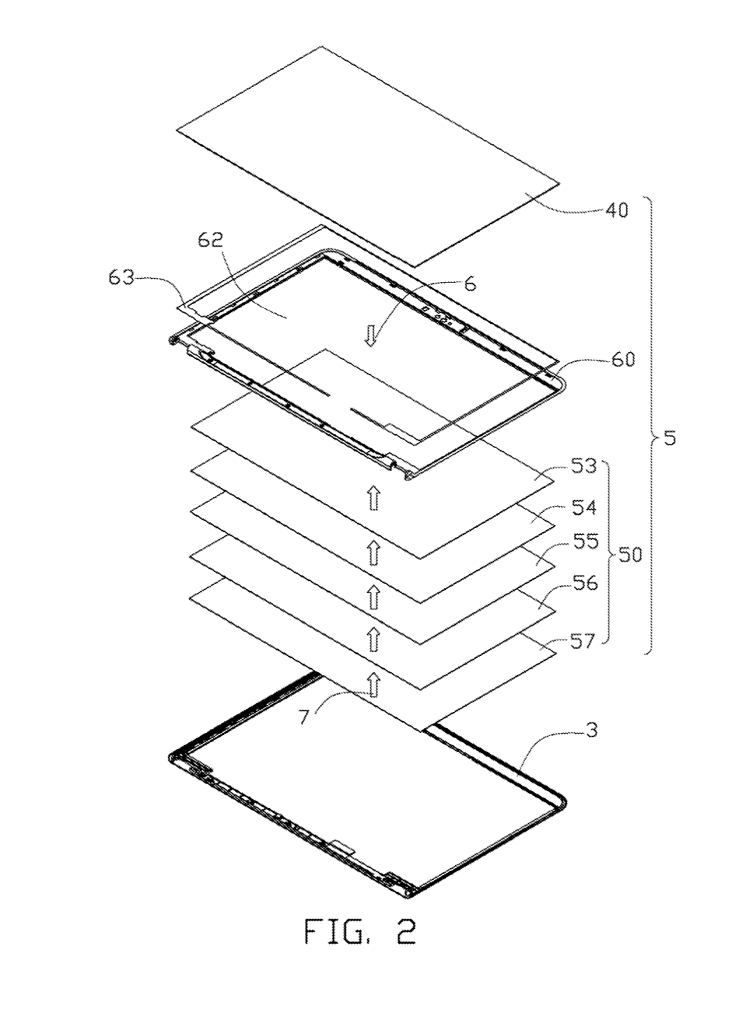

Referring to FIG. 2, the display 5 includes a display screen 40, a display panel 50 and a frame 60. The display panel 50 includes a plurality of engaging elements. The plurality of engaging elements includes a liquid crystal cell 53, a prism lens sheet 54, a diffuser 55, a light guide plate 56 and a reflection plate 57. The frame 60 is substantially rectangle, and defines a receiving space 62 for receiving the display panel 50. In the embodiment, the display screen 40 is a planar glass plate.

In assembly, the display screen 40 is fixed to a surface of the frame 60 opposite to the cover 3 via a double faced adhesive tape 63 in a first direction indicated by the arrow 6. Then, the engaging elements of the display panel 50 are fixed to a surface of the display screen 40 adhered on the frame 60 in a second direction indicated by the arrows 7 and are received in the receiving space 62. In detail, the liquid crystal cell 53, the prism lens sheet 54, the diffuser 55, the light guide plate 56 and the reflection plate 57 are fixed on the surface of the display screen 40 adhered on the frame 60 one by one in the second direction. Thus, the display screen 40 and the engaging elements of the display panel 50 are assembled together and form to an integrated display 5. Finally, the integrated display 5 is fixed to the cover 3 via a double faced adhesive tape.

In the embodiment, the display screen 40 firstly is fixed to the frame 60. Then, based on the display screen 40, the liquid crystal cell 53, the prism lens sheet 54, the diffuser 55, the light guide plate 56 and the reflection plate 57 are fixed on the display screen 40 in order and form to the integrated display 5. Because the surface of the display screen 40 is more even than the surface of cover 3, the engaging elements of the display panel 50 assembled on the display screen 40 is more even than the engaging elements of the display panel 10 assembled on the cover 2. Because the display screen 40 firstly fixes on the frame 60, when the engaging elements of the display panel 50 fix to the display screen 40, the frame 60 is capable of preventing the engaging elements of the display panel 50 from moving. Furthermore, the engaging elements of the display panel 50 and the display screen 40 are previously assembled together, thus, it is easy for an operator to assemble the integrally formed display panel 50 and the display screen 40 on the cover 2 even over other components, such as, an antenna and a camera, assembled on the cover 2 firstly.

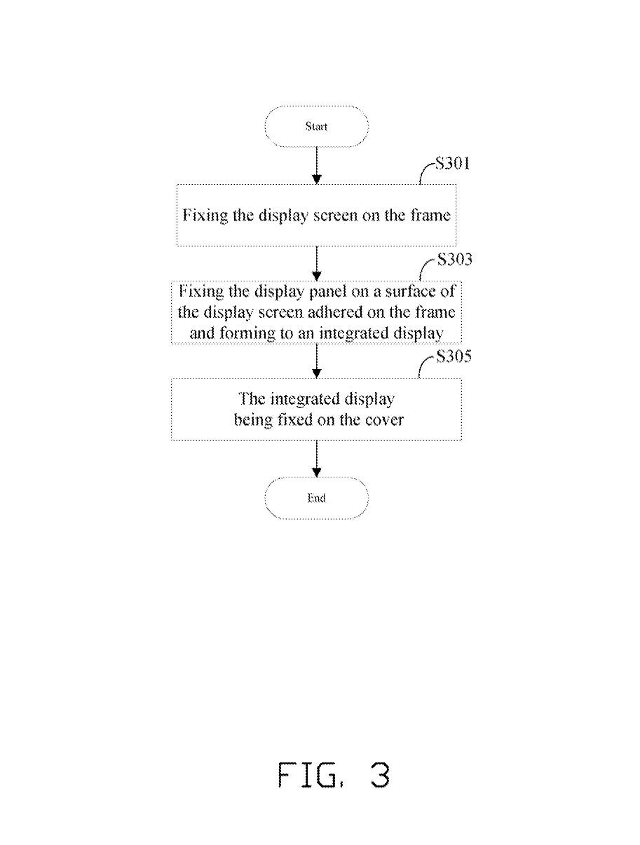

FIG. 3 shows that an assembly method of the display 5. The assembly method includes the following steps:

Step 301, fixing the display screen 40 on the frame 60.

Step 303, fixing the display panel 50 on a surface of the display screen 40 adhered to the frame 60 and forming to an integrated display 5. In detail, the display panel 50 includes the liquid crystal cell 53, the prism lens sheet 54, the diffuser 55, the light guide plate 56 and the reflection plate 57. The display panel 50 includes the liquid crystal cell 53, the prism lens sheet 54, the diffuser 55, the light guide plate 56 and the reflection plate 57 are adhere to the display screen 40 one by one and are received in the receiving space 62 of the frame 60. Thus, the display panel 50 and the display screen 40 are form to the integrated display 5.

Step 305, fixing the integrated display 5 on the cover 3.

Although information and the advantages of the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A display of an electronic device comprising a cover for fixing the display, the display comprising:
a display screen; and
a display panel with a plurality of engaging elements;
wherein the engaging elements of the display panel are fixed to the display screen and form an integrated display, and the integrated display is secured to the cover.

2. The display as claimed in claim 1, wherein the plurality of engaging elements of the display panel comprises a frame defining a receiving space; the display screen is adhered to the frame, the display panel is fixed on the display screen and is received in the receiving space.

3. The display as claimed in claim 1, wherein the display panel comprises a liquid crystal cell, a prism lens sheet, a diffuser, a light guide plate and a reflection plate; the liquid crystal cell, the prism lens sheet, the diffuser, the light guide plate and the reflection plate adhere on the display screen in a predetermined order.

4. The display as claimed in claim 1, wherein the display screen is a planar glass plate.

5. An assembly method for mounting a display to a cover, the display comprising a display screen and a display panel, comprising:
fixing the display panel to the display screen; and
mounting the display panel together with the display screen to the cover.

6. The assembly method as claimed in claim 5, wherein the display panel comprises a frame defining a receiving space; the display screen is fixed on the frame, the display panel is fixed to the display screen and is received in the receiving space.

7. The assembly method as claimed in claim 6, wherein the frame is secured to the cover with the engaging elements and the display screen.

8. The assembly method as claimed in claim 5, wherein the display panel comprises a liquid crystal cell, a prism lens sheet, a diffuser, a light guide plate and a reflection plate, the liquid crystal cell, the prism lens sheet, the diffuser, the light guide plate and the reflection plate adhere on the display screen in a predetermined order and form to an integrated display.

9. The assembly method as claimed in claim 8, wherein the integrated display is fixed to the cover.

10. The assembly method as claimed in claim 5, wherein the display screen is a planar glass plate.

11. An electronic device, comprising:
a cover, and
a display secured to the cover; the display comprising:
a display screen; and
a display panel secured to the display screen and having a plurality of engaging elements;
wherein the engaging elements of the display panel are fixed to the display screen and form an integrated display, and the integrated display is secured to the cover.

12. The electronic device as claimed in claim 11, wherein the engaging elements of the display panel comprises a frame defining a receiving space; the display screen is fixed on the frame, the display panel is fixed on the display screen and is received in the receiving space.

13. The electronic device as claimed in claim 11, wherein the display panel comprises a liquid crystal cell, a prism lens sheet, a diffuser, a light guide plate and a reflection plate; the liquid crystal cell, the prism lens sheet, the diffuser, the light guide plate and the reflection plate is adhered on the display screen in a predetermined order.

14. The electronic device as claimed in claim 11, wherein the display screen is a planar glass plate.
